(19) United States
(12) Patent Application Publication
(10) Pub. No.: US 2004/0240806 A1
(43) Pub. Date: Dec. 2, 2004

(54) Fiber optic cable having a binder

(76) Inventors: Jason C. Lail, Conover, NC (US); James E. Triplett, Conover, NC (US); H. Edward Hudson II, Conover, NC (US); Larry W. Field, Hickory, NC (US); Catharina L. Tedder, Catawaba, NC (US)

Correspondence Address: CORNING CABLE SYSTEMS LLC, P O BOX 489, HICKORY, NC, 28603, US

(21) Appl. No.: 10/448,874

(22) Filed: May 30, 2003

(51) Int. Cl. G02B 6/44

(52) U.S. Cl. 385/100

(57) ABSTRACT

A fiber optic cable and manufacturing methods therefor includes a cable core that having at least one optical waveguide and at least one binder. The cable also includes a polymer layer being disposed about the at least one binder. During the extrusion of the polymer layer, the polymer layer at least partially melts the at least one binder when extruded thereover, thereby at least partially bonding the at least one binder with the polymer layer. In other embodiments, the cable is a dry fiber optic cable.

### FIELD OF THE INVENTION

The present invention relates generally to binders for fiber optical cables. More specifically, the invention relates to fiber optic cables having one or more binders that at least partially melt during the extrusion of a polymer layer thereover and manufacturing methods therefor.

### BACKGROUND OF THE INVENTION

Fiber optic cables include optical waveguides such as optical fibers that transmit optical signals, for example, voice, video, and/or data information. Generally speaking, a fiber optic cable includes a cable core and a cable sheath. The optical fibers are disposed within the cable core and the cable sheath surrounds the cable core, thereby providing environmental protection to the cable core. Consequently, when a craftsman must access the optical fibers, the sheathing system must be opened so that the cable core can be exposed and the optical fibers can be accessed.

Depending on the type and/or complexity of the fiber optic cable, the manufacture of fiber optic cables requires several manufacturing steps along one or more manufacturing lines. During the manufacture, a fiber optic cable can include the application of one or more conventional binders for holding a portion of the cable together before the completion of the cable. For example, FIG. 1 depicts a monotube fiber optic cable 10 that may require more than one manufacturing line. A first manufacturing line is used for making optical fiber ribbons 13 by grouping together individual optical fibers in a matrix material. A second manufacturing line is used for placing ribbons 13 into a ribbon stack and extruding a tube 14 around the ribbon stack. Finally, a third manufacturing line wraps a water-swellable tape 15 around tube 14 and one or more conventional binders 17 made of nylon or polyester (PET) are stranded around water-swellable tape 15, thereby holding the tape in place and forming a cable core. Conventional binder(s) 17 aids the manufacturing of fiber optic cable 10 by inhibiting water-swellable tape 15 from shifting or coming off during the manufacturing process. Thereafter, a cable sheath 18 is formed over the cable core by placing at least one strength member 18a adjacent to the cable core and extruding a cable jacket 18b thereover. Cable sheath 18 also serves for holding the cable together, thereby providing a robust structure.

In this particular fiber optic cable design, water-swellable tape 15 serves several functions. First, water-swellable tape 15 inhibits the migration of water between the cable core and the cable sheath if water should penetrate the fiber optic cable. Second, water-swellable tape 15 inhibits the extruded material of cable jacket 18b from bonding with tube 14. If cable jacket 18b bonds with tube 14, then the craftsman has difficulty removing cable sheath 18 and accessing the optical fibers within the cable core. Thus, water-swellable tape 15 generally is sized to overlap at the seam and is secured in place around the tube using one or more conventional binder(s) 17. Conventional binder(s) 17 holds the water-swellable tape in place, thereby inhibiting the cable jacket from bonding with tube 14.

However, using one or more conventional binders for securing a water-swellable tape has disadvantages. Specifically, when the craftsman must access the optical fibers within the fiber optic cable he must open the cable sheath to access the cable core. After accessing the cable core, the craftsman must then remove the binder(s) from around the cable core using, for instance, a special tool such as a seam ripper. This is a time consuming process that requires tools. Moreover, the craftsman must be careful not to damage the optical fibers within the cable core. Additionally, other cable designs can have numerous binders for holding portion of the cable together during the manufacturing process.

### SUMMARY OF THE INVENTION

The present invention is directed to a fiber optic cable including a cable core having at least one optical waveguide and at least one binder. A polymer layer is disposed about the at least one binder so that the polymer layer at least partially melts the at least one binder when extruded thereover, thereby at least partially bonding the at least one binder with the polymer layer.

The present invention is also directed to a fiber optic cable including a cable core having at least one optical waveguide and at least one binder. A polymer layer is disposed about the at least one binder, wherein the at least one binder has a melt point that is about equal to or below a melt point of the polymer layer.

The present invention is further directed to a dry fiber optic cable including a dry cable core having at least one optical waveguide and at least one binder. A polymer layer is disposed about the at least one binder so that the polymer layer at least partially melts the at least one binder when extruded thereover, thereby at least partially bonding the at least one binder with the polymer layer.

Additionally, the present invention is directed to a method of manufacturing a fiber optic assembly including the steps of paying off at least one optical waveguide that forms a portion of a core, paying off at least one binder that forms a portion of the core, and extruding a polymer layer about the core. The polymer layer at least partially melts the at least one binder when extruded thereover, thereby at least partially bonding the at least one binder with the polymer layer.

### BRIEF DESCRIPTION OF THE FIGURES

FIG. 1 is a cross-sectional view of a fiber optic cable having a conventional binder wrapped about the cable core.

FIG. 2 is a cross-sectional view of a fiber optic cable according to the present invention.

FIG. 2a is a perspective view of the cable core of FIG. 2 without the cable sheathing.

FIG. 2b is a perspective view of the fiber optic cable of FIG. 2 after a portion of the cable sheathing is removed.

FIG. 3 is a cross-sectional view of another fiber optic cable according to the present invention.

FIG. 4 is a cross-sectional view of a fiber optic cable according to another embodiment of the present invention.

FIG. 5 is a cross-sectional view of a fiber optic cable according to another embodiment of the present invention.

FIG. 6 is a cross-sectional view of a fiber optic cable according to one embodiment of the present invention.

FIG. 7 is an exemplary schematic representation of a manufacturing line according to the present invention.

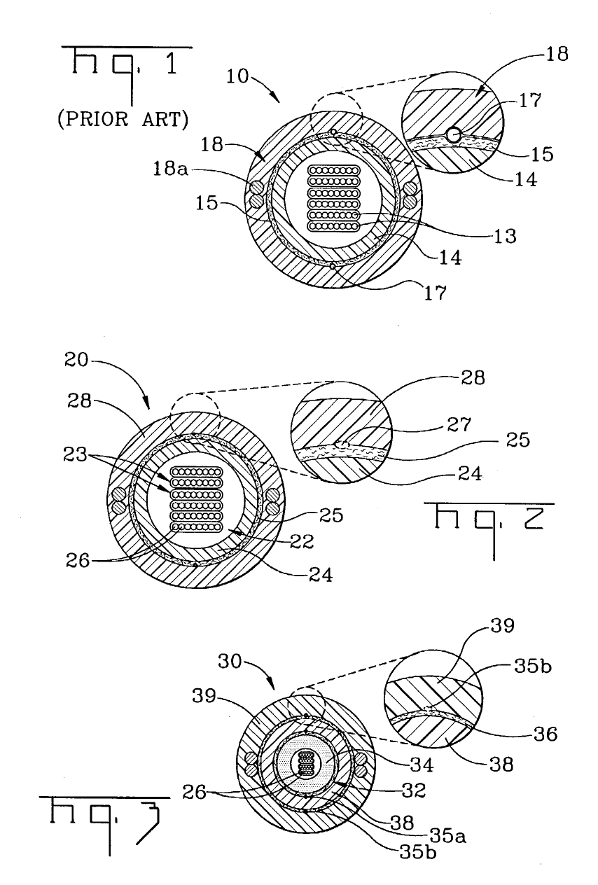

### DETAILED DESCRIPTION OF THE INVENTION

The present invention will now be described more fully hereinafter with reference to the accompanying drawings showing preferred embodiments of the invention. The invention may, however, be embodied in many different forms and should not be construed as limited to the embodiments set forth herein; rather, these embodiments are provided so that the disclosure will fully convey the scope of the invention to those skilled in the art. The drawing are not necessarily drawn to scale but are configured to clearly illustrate the invention.

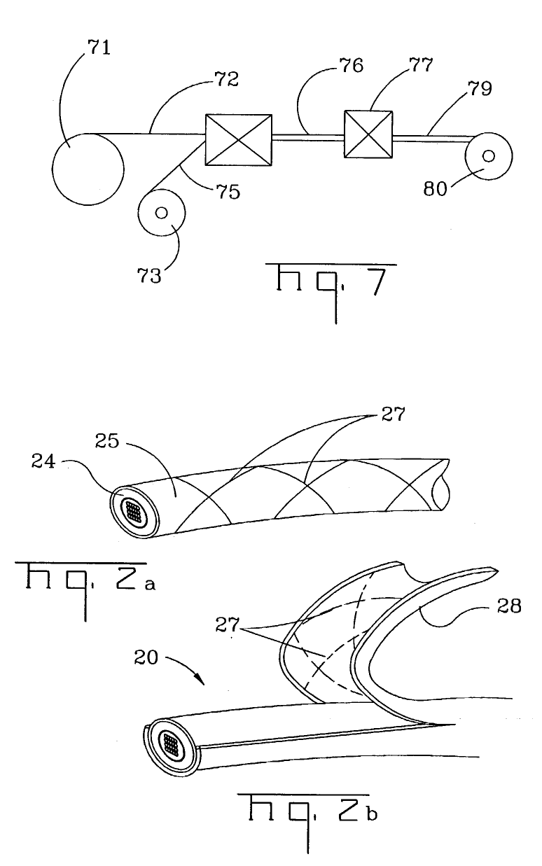

Illustrated in FIG. 2 is a fiber optic cable 20 according to one embodiment of the present invention. Fiber optic cable 20 (hereinafter cable) includes a cable core 22 having at least one optical waveguide 26 and a polymer layer 28 extruded about cable core 22. In this case, cable core 22 includes a plurality of optical fiber ribbons 23 (hereinafter ribbons), a tube 24, a water-swellable tape 25, and at least one binder 27. The plurality of ribbons 23 are arranged in a ribbon stack and are at least partially disposed within tube 24. Water-swellable tape 25 generally surrounds tube 24 and in addition to inhibiting water migration it inhibits polymer layer 28 from bonding with tube 24. Binder 27 is used for holding water-swellable tape 25 in place about tube 24 during the manufacture of cable 20. Additionally, according to the concepts of the present invention, binder 27 is selected so that it at least partially melts (as shown in the detail of FIG. 2) when polymer layer 28 is extruded thereover. In other words, after polymer layer 28 is extruded over binder 27, binder 27 at least partially melts with, and at least partially bonds with polymer layer 28 during the extrusion process of the same.

Consequently, as depicted in FIG. 2b when the craftsman opens, or removes the cable jacket formed by polymer layer 28, binder 27 at least partially comes off with polymer layer 28 because it is at least partially bonded therewith. The bonding is illustrated as the dashed lines on the inner surface of polymer layer 28. This bonding between binder 27 and polymer layer 28 generally eliminates the time consuming step of removing binder 27 from cable core 22 when accessing the optical waveguides. This step is eliminated because unlike conventional cables, binder 27 is removed, or pulled away, when opening/removing polymer layer 28. Moreover, binder 27 is removed without using a tool to rip the binder as is typical with a conventional binder. In preferred embodiments, the binder essentially melts when the polymer layer is extruded thereover (detail of FIG. 3). In this cable design, polymer layer 28 is a cable jacket that along with strength members 29 form a cable sheath; however in other embodiments polymer layer 28 can take other forms.

The at least partial melting of binder 27 occurs during the transfer of heat to the binder during the extrusion of polymer layer 28. Consequently, during extrusion polymer layer 28 should transfer heat sufficient for at least partially melting binder 27. In other words, the extrusion process for the polymer layer of the present should cause the binder to reach its melting point and/or softening of the binder to occur. As used herein, the melting point is defined as raising the internal energy of the polymeric molecules so as to cause the polymer molecules to become disentangled, thereby overcoming intermolecular forces. Under these conditions the polymer molecules of the binder are able to at least partially bond with the polymer layer being extruded thereover.

Additionally, most polymers have crystalline and amorphous regions. Semi-crystalline materials are considered to have a distinct melt point. The amorphous regions have a broad melting range described as a glass transition temperature T_{g}. On the other hand, the crystalline regions have relatively sharp melting points described by a melting point T_{M} that is generally higher than the glass transition temperature T_{g}. Thus, most polymer materials will start to soften at the lower glass transition temperature T_{g}, which requires less energy, but may require more energy to accomplish bonding with the polymer layer.

Binder 27 is preferably a polymeric material that has a relatively low melting point compared with the extrusion temperature of polymer layer 28. Preferred polymeric materials for binder 27 include thermoplastics such as polyethylenes, polypropylenes, polycarbonates, and elastomers; however, other suitable materials that at least partially melt when polymer layer 28 is extruded thereover can be used. In one embodiment, the binder is a 300 denier twisted polypropylene available under the tradename Soft TR-350 from Ashley Industries, Ltd. of Greensboro, N.C. This binder includes a plurality of polypropylene filaments Z-twisted about 2.5 times per inch with a melt point of about 145° C. Twisting the filaments provides smaller packaging for the binder and aids in inhibiting snagging of the binder during its application. This binder also includes a silicone finish that act as a lubricant. Other binders according to the present invention can be a single strand and/or have other shapes such as flat. Moreover, binders can have other suitable finishes or additives for purposes such as tackifying or abrasion resistance.

Additionally, the degree of melting and/or softening of binder 27 may be influenced by, among other factors, the selection of a material for polymer layer 28 and the extrusion processing parameters of the same. In preferred embodiments, the glass transition temperature T_{g} or melting point T_{M} of binder 27 is selected so that the binder essentially melts when polymer layer 28 is extruded thereover. In other words, binder 27 essentially melts and bonds with the inner surface of polymer layer 28, which in turn holds the cable core together.

By way of example, a melting point T_{M} of a polyethylene binder 27 is about 130° C. and a die exit temperature of a polyethylene of polymer layer 28 during the extrusion process is about 230° C., thereby at least partially melting binder 27 during extrusion of polymer layer 28. Additionally, a ratio between the melt point of binder 27 and a melt point of the polymer layer 28 can also be specified. For instance, the melt point ratio can be about 1.0 or less, preferably about 0.9 or less, and more preferably about 0.8 or less. Likewise, a ratio between the melt point of binder 27 and a die exit temperature of polymer layer 28 may be expressed, for instance, the melt point/die exit temperature ratio is about 1.0 or less, preferably about 0.9 or less, and more preferably about 0.8 or less.

Illustratively, Table 1 lists the melt point of several materials in order to calculate a melt point/die exit temperature ratio. For instance, if a polymer layer was extruded at a die exit temperature of 230° C., conventional binder materials such as polyester (PET) and Nylon have a melt point/die exit temperature ratio greater than one. Consequently, the polymer layer would not at least partially melt conventional binders. On the other hand, the polyethylene and polypropylene have respective melt point/die exit temperature ratios of 0.64 and 0.72 and are suitable with the concepts of the present invention. Additionally, because aramid fibers do not have a melt point they are not suitable for the concepts of the present invention.

TABLE 1

| Material | Melt Point (C.) |
|---|---|
| Polyester (PET) | 256° |
| Nylon | 254° |
| Polyethylene | 147° |
| Polypropylene | 165° |
| Aramid | None |

Another ratio that is useful for selecting a binder and a polymer layer using materials from the same polymer class, i.e. both polyethylenes, is a melt index ratio. In other words, the melt index of binder 27 is about equal to, or lower than, the melt index of polymer layer 28. In preferred embodiments, the melt index of binder 27 is selected so that binder 27 essentially melts when polymer layer 28 is extruded thereover. Additionally, a melt index ratio between a melt index of binder 27 and a melt index of the polymer layer 28 can also be specified. For instance, the melt index ratio can be about 1.0 or less, preferably about 0.9 or less, and more preferably about 0.8 or less.

Additionally, binder 27 can have a color that is different or matches polymer layer 28. If the color of the binder is different such as yellow with a black polymer layer, it will be relatively easy for the craftsman to locate binder 27 after the cable sheath is removed. In other embodiments, the binder can have a color similar to the polymer layer, thereby making it difficult to locate the binder after the cable sheath is removed. Stated another way, the craftsman would not realize that a binder was used during the manufacture of the cable.

In FIG. 2, optical waveguide 26 is an optical fiber that forms a portion of optical fiber ribbon 23. More specifically, optical waveguides 26 are a plurality of single-mode optical fibers in a ribbon format that form a portion of a ribbon stack. The ribbon stack can include helical or S-Z stranding. Additionally, other types or configurations of optical waveguides can be used. For example, optical waveguide 26 can be multi-mode, pure-mode, erbium doped, polarization-maintaining fiber, or other suitable types of light waveguides. Moreover, optical waveguide 26 can be loose or in bundles. Each optical waveguide 26 may include a silica-based core that is operative to transmit light and is surrounded by a silica-based cladding having a lower index of refraction than the core. Additionally, one or more coatings can be applied to optical waveguide 26. For example, a soft primary coating surrounds the cladding, and a relatively rigid secondary coating surrounds the primary coating. Optical waveguide 26 can also include an identifying means such as ink or other suitable indicia for identification. Suitable optical fibers are commercially available from Corning Incorporated of Corning, N.Y.

Tube 24 is preferably formed from a polymeric material and houses a portion of at least one optical waveguide 26. In this embodiment, tube 24 may be filled with a thixotropic material to inhibit the migration of water inside tube 24. In other embodiments, tube 24 can be a portion of a dry cable core by using one or more water-swellable tapes, yarns, powders, coatings, or components inside tube 24 for blocking water migration. Furthermore, tube 24, or other components of the cable, can be formed from flame-retardant polymeric materials, thereby increasing flame-retardant properties of the cable.

In the case of cable 20, polymer layer 28 forms a cable jacket that is a portion of the cable sheath. Polymer layer 28 can be formed from any suitable polymeric material that during extrusion at least partially melts binder 27. In other embodiments, polymer layer 28 can form other portions of a cable such as an inner jacket or a tube that at least partially melts at least one binder. Additionally, by selecting the material used for the binder, the material used for the polymer layer, and/or the extrusion process the degree of melting of the binder may be influenced.

The concepts of the present invention can also be used with other configurations or cable designs. For instance, embodiments of the present invention can use more than one binder such as two binders that are counter-helically wound around a water-swellable tape. Additionally, other embodiments can use one or more binders of the present invention with different cable designs and/or disposed in different locations within a cable design. Moreover, the polymer layer that at least partially melts the at least one binder may be in a form other than a cable jacket.

For instance, as depicted in FIG. 3, binders of the present invention are advantageous in a dry fiber optic cable 30 with a dry insert 34 as disclosed in U.S. patent application Ser. No. 10/326,022, the disclosure of which is incorporated herein by reference. As shown, this embodiment includes at least two binders 35a and 35b disposed in two different radial locations according to the present invention. Specifically, cable 30 includes a dry cable core 32 having at a first radially disposed binder 35a with a polymer layer 38 that forms a tube disposed about binder 35a and at least partially melts binder 35a during extrusion thereof. A second radially disposed binder 35b is disposed about a water-swellable tape 36 and has a polymer layer 39 extruded thereover as part of a cable sheath. In preferred embodiments, the polymer layers essentially melt the respective binders. Dry insert 34 includes one or more layers, and in preferred embodiments dry insert 34 includes a foam layer and a water-swellable layer. Dry insert 34 surrounds at least one optical waveguide 26 and is secured by at least one binder 35a, thereby forming a portion of a dry cable core 32. The foam layer of dry-insert 34 is preferably a compressible tape that assists in coupling the at least one optical fiber with the tube. Additionally, binder 35a along with other optional means can assist coupling a portion of dry insert 34 with polymer layer 38 that forms the tube. For example, other optional means for coupling can include adhesives, glues, elastomers, and/or polymers that are disposed on at least a portion of the surface of dry insert 34 that contacts the extruded polymer layer 38 that forms the tube. However, binder 35a may be have a tailored degree of friction with polymer layer 38 so that an optional means of coupling is not necessary.

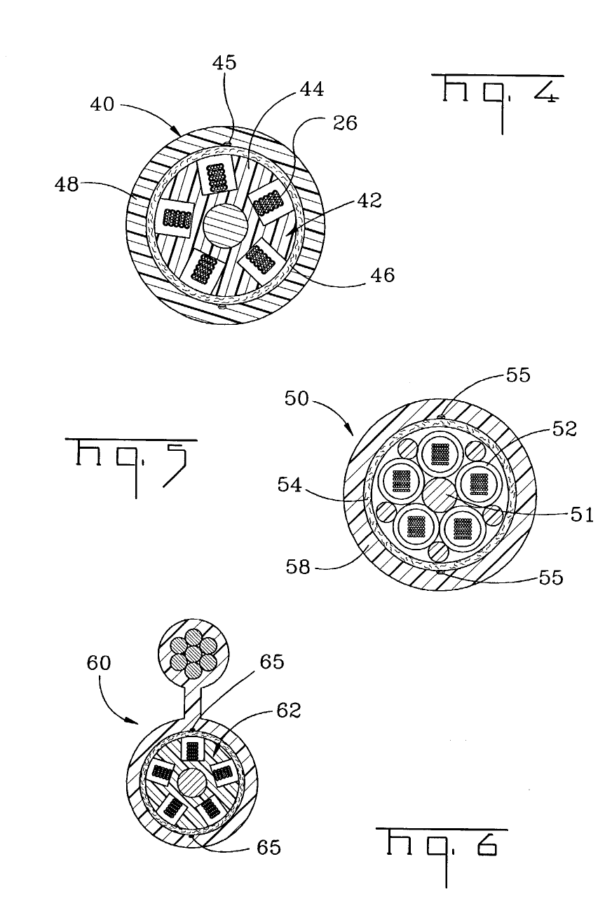

Depicted in FIG. 4 is another cable design using the concepts of the present invention. Specifically, cable 40 includes a slotted cable core 42 having at least one optical waveguide 26 disposed in at least one of the slots of slotted core 44. A water-swellable tape 46 generally surrounds slotted core 44 and in addition to inhibiting water migration it inhibits polymer layer 48 from bonding with slotted core 44. Binder 45 is used for holding water-swellable tape 46 in place about slotted core 44 during the manufacture of cable 40. In this cable design, polymer layer 48 is a cable jacket FIG. 5 is loose tube cable design using the concepts of the present invention. In particular, cable 50 includes a central member 51 having a plurality of tube assemblies 52 stranded therearound. At least one of tube assemblies 52 includes at least one optical waveguide disposed therein. Disposed about tube assemblies 52 is a tape such as a water-swellable tape 54 that is secured by at least one binder 55 according to the present invention. A polymer layer 58 forming a cable jacket is extruded over binder 55, thereby at least partially melting binder 55. Additionally, binders 65 of the present invention can be used in other cable designs such as a cable core 62 portion of figure-8 cable 60 (FIG. 6).

An exemplary method of manufacturing cables or assemblies according to the present invention is schematically illustrated in FIG. 7. At least one optical fiber 72 is paid off a reel 71 and at least one binder 75 is paid off reel 73, thereby forming a portion of a cable core 76. A polymer layer (not shown) is extruded about cable core 76 using cross-head extruder 7.7, thereby forming at least a portion of a cable 79. The heat transfer due to the extrusion of the polymer layer at least partially melts the at least one binder 75 and causes at least partially bonding between the at least one binder 75 and polymer layer. Preferably, the melt point/die exit temperature ratio is less than one. Thereafter, at least a portion of a cable 79 is wound onto reel 80.

Many modifications and other embodiments of the present invention, within the scope of the appended claims, will become apparent to a skilled artisan. For example, any suitable cable designs can use the concepts of the present invention such as cables having multiple jackets, or other suitable cable designs. Additionally, cables of the present invention can include other suitable components such as ripcords, filler rod, tapes, films, or armor therein. Therefore, it is to be understood that the invention is not limited to the specific embodiments disclosed herein and that modifications and other embodiments may be made within the scope of the appended claims. Although specific terms are employed herein, they are used in a generic and descriptive sense only and not for purposes of limitation. The invention has been described with reference to silica-based optical fibers, but the inventive concepts of the present invention are applicable to other suitable optical waveguides and/or cable configurations as well.

1. A fiber optic cable comprising:
a cable core, the cable core having at least one optical waveguide and a dry insert, the dry insert being disposed generally around the at least one optical waveguide;
at least one binder, the at least one binder being a portion of the cable core; and
a polymer layer, the polymer layer being disposed about the at least one binder, wherein the polymer layer at least partially melts the at least one binder when extruded thereover, thereby at least partially bonding the at least one binder with the polymer layer.

2. The fiber optic cable of claim 1, the at least one binder having a melt point that is about equal to or below a melt point of the polymer layer.

3. The fiber optic cable of claim 1, further comprising a water-swellable tape disposed radially inward of the at least one binder.

4. The fiber optic cable of claim 1, the polymer layer being a tube.

5. The fiber optic cable of claim 1, the polymer layer being a cable jacket.

6. (cancelled)

7. (cancelled)

8. The fiber optic cable of claim 1, the at least one binder essentially melting when the polymer layer is extruded thereover.

9. The fiber optic cable of claim 1, a melt point ratio between the at least one binder and the polymer layer being about 0.9 or less.

10. The fiber optic cable of claim 1, a melt point ratio between the at least one binder and the polymer layer being about 0.8 or less.

11. A fiber optic cable comprising:
a cable core, the cable core having at least one optical waveguide and a dry insert, the dry insert being disposed about the at least one optical waveguide;
at least one binder, the binder being a portion of the cable core; and
a polymer layer, the polymer layer being disposed about the at least one binder, wherein the at least one binder has a melt point that is about equal to or below a melt point of the polymer layer.

12. The fiber optic cable of claim 11, the polymer layer at least partially melts the at least one binder when extruded thereover.

13. The fiber optic cable of claim 11, further comprising a water-swellable tape disposed radially inward of the at least one binder.

14. The fiber optic cable of claim 11, the polymer layer being a tube.

15. The fiber optic cable of claim 11, the polymer layer being a cable jacket.

16. (cancelled)

17. (cancelled)

18. The fiber optic cable of claim 11, the at least one binder essentially melting when the polymer layer is extruded thereover.

19. The fiber optic cable of claim 11, a melt point ratio between the at least one binder and the polymer layer being about 0.9 or less.

20. The fiber optic cable of claim 11, a melt point ratio between the at least one binder and the polymer layer being about 0.8 or less.

21. A dry fiber optic cable comprising:
a dry cable core, the dry cable core having at least one optical waveguide and a dry insert, the dry insert being disposed about the at least one optical waveguide;
at least one binder, the binder being a portion of the dry cable core, the at least one binder being disposed about the dry insert; and
a polymer layer, the polymer layer being disposed about the at least one binder, wherein the polymer layer at least partially melts the at least one binder when extruded thereover, thereby at least partially bonding the at least one binder with the polymer layer.

22. (cancelled)

23. The dry fiber optic cable of claim 21, wherein the polymer layer is a tube disposed around the at least one binder and the dry cable core, and further comprising a water-swellable tape disposed radially outward of the tube being secured by a second binder, wherein the second binder at least partially melts when a cable jacket is extruded thereover.

24. The dry fiber optic cable of claim 21, the at least one binder having a melt point that is about equal to or below a melt point of the polymer layer.

25. The fiber optic cable of claim 21, further comprising a water-swellable tape disposed between the cable core and the at least one binder.

26. The fiber optic cable of claim 21, the polymer layer being a tube.

27. The fiber optic cable of claim 21, the polymer layer being a cable jacket.

28. The fiber optic cable of claim 21, the at least one binder essentially melting when the polymer layer is extruded thereover.

29. The fiber optic cable of claim 21, a melt point ratio between the at least one binder and the polymer layer being about 0.9 or less.

30. The fiber optic cable of claim 21, a melt point ratio between the at least one binder and the polymer layer being about 0.8 or less.

31. The fiber optic cable of claim 21, the at least one binder aiding in coupling between the dry cable core and the polymer layer.

32. A method of manufacturing a fiber optic assembly comprising the steps of:
paying off at least one optical waveguide that forms a portion of a core;
paying off at least one dry insert and positioning the dry insert generally around the at least one optical waveguide;
paying off at least one binder that forms a portion of the core; and
extruding a polymer layer about the core, wherein the polymer layer at least partially melts the at least one binder when extruded thereover, thereby at least partially bonding the at least one binder with the polymer layer.

33. The method of claim 32, the step of extruding essentially melting the at least one binder when the polymer layer is extruded thereover.

34. The fiber optic cable of claim 1, the dry insert comprising a tape having a foam layer and a water-swellable layer.

35. The fiber optic cable of claim 11, the dry insert comprising a tape having a foam layer and a water-swellable layer.

36. The dry fiber optic cable of claim 21, the dry insert comprising a tape having a foam layer and a water-swellable layer.

37. The method of 32, the dry insert comprising a tape having a foam layer and a water-swellable layer.
